(19) United States
(12) Patent Application Publication
(10) Pub. No.: US 2024/0381388 A1
(43) Pub. Date: Nov. 14, 2024

(54) POINT-TO-MULTIPOINT COMMUNICATIONS

(71) Applicant: Nokia Technologies Oy, Espoo (FI)

(72) Inventors: Naizheng ZHENG, Beijing (CN); David NAVRATIL, Espoo (FI); Jarkko Tuomo KOSKELA, Oulu (FI); Athul PRASAD, Naperville, IL (US); Ugur Baran ELMALI, Munich (DE); David BHATOOLAUL, Swindon (GB)

(21) Appl. No.: 18/687,467

(22) PCT Filed: Oct. 19, 2021
(86) PCT No.: PCT/CN2021/124548

§ 371 Date: Feb. 28, 2024

(51) Int. Cl. H04W 72/30; H04W 72/20

(52) U.S. Cl. CPC H04W 72/30; H04W 72/20

(57) ABSTRACT

Apparatuses and methods are provided to enable a receiver device monitoring a control channel configured for carrying information indicating transmission types of point-to-multipoint services detect a point-to-multipoint service of interest. The device can further detect an indication of a transmission type associated with the point-to-multipoint service of interest. In response a request can be sent for a configuration enabling reception of the indicated transmission type of the point-to-multipoint service of interest on a point-to-multipoint traffic channel. In the absence of said further detecting, the device can refrain from sending the request for the configuration for reception of the transmission type of the point-to-multipoint service.

### FIELD

Methods, apparatuses and computer program products for point-to-multipoint communications in a communication system are disclosed.

### BACKGROUND

Communications may be provided, for example, by means of a communication network and one or more compatible communication devices. In a mobile or wireless communication system at least a part of data communication between at least two devices occurs over a wireless or radio link. A communication device at a network side provides an access node to the system and may comprise a station providing appropriate signal receiving and transmitting apparatus for enabling communications with devices serviced by it. A communication device provided with appropriate signal receiving and transmitting apparatus can communicate with the access node.

The communication system and associated devices typically operate in accordance with a given standard or specification which sets out what the various entities associated with the system are permitted to do and how that should be achieved. Communication protocols and/or parameters which shall be used for the connection are also typically defined. For example, 3rd Generation Partnership Project (3GPP) has been standardizing various aspect of the communications system to ensure interoperability of the equipment by various suppliers.

Point-to-multipoint communications refers to one-to-many type of communications where a station, for example a base station or another access node of a mobile communication system can transmit simultaneously to more than one receiving device in its service area, e.g., via multicast and/or broadcast transmissions.

### SUMMARY

In accordance with an aspect there can be provided an apparatus for a receiver device, comprising at least one processor and at least one memory including a computer program code, the at least one memory and computer program code configured to, with the at least one processor, cause the apparatus at least to monitor a control channel configured for carrying information indicating transmission types of point-to-multipoint services, detect, based on said monitoring, a point-to-multipoint service of interest, further detect, based on said monitoring, an indication of a transmission type associated with the point-to-multipoint service of interest, and in response send a request for a configuration enabling reception of the indicated transmission type of the point-to-multipoint service of interest on a point-to-multipoint traffic channel, and in the absence of said further detecting, refrain from sending the request for the configuration for reception of the transmission type of the point-to-multipoint service.

The apparatus may be configured to receive the requested configuration in a system information block.

The apparatus may be configured to, when in the state of refraining from sending the request for the configuration for the transmission type of the point-to-multipoint service, monitor for point-to-multipoint transmissions of the point-to-multipoint service on the point-to-multipoint traffic channel based on synchronization signal blocks.

The apparatus may be configured to receive the configuration on a broadcast channel.

The apparatus may be configured to store configurations for transmission types in a memory, and to determine whether the indicated configuration is already stored in the memory before triggering sending of the request.

The apparatus may be configured to detect information indicating which configuration of a multiple of possible configurations is to be used.

In accordance with another aspect there can be provided an apparatus for controlling point-to-multipoint services, comprising at least one processor and at least one memory including a computer program code, the at least one memory and computer program code configured to, with the at least one processor, cause the apparatus at least to send, on a control channel configured for carrying information indicating transmission types of point-to-multipoint services, an indication of a transmission type of a point-to-multipoint service for use by receiver devices in determining, if the point-to-multipoint service is of interest, whether to request for a configuration associated with the transmission type in order to receive the point-to-multipoint service of interest on a traffic channel, receive in response a request from at least one receiver device for a configuration enabling reception, by the receiver device, of the indicated transmission type on a point-to-multipoint traffic channel, and send the configuration to the at least one receiver device.

The apparatus for controlling may be configured to signal the requested configuration to the at least one receiver device in a system information block.

The apparatus for controlling may be configured to signal information indicating which configuration of a multiple of possible configurations is to be used by the receiving devices.

The apparatus for controlling may be configured to cause the signalling of the configuration on a broadcast channel.

The at least one receiver device monitoring the control channel is in a radio resource control idle or inactive state.

The point-to-multipoint service may comprise a multicast and/or broadcast service. The indication of the transmission type may comprise an indication of a tracking reference signal for the multicast and/or broadcast service. The control channel may comprise a multicast control channel. The point-to-multipoint traffic channel may comprise a multicast traffic channel. The configuration may comprise a tracking reference signal configuration for a multicast broadcast service.

In accordance with an aspect there can be provided a method for receiving point-to-multipoint services, the method comprising monitoring, by a receiver device, a control channel configured for carrying information indicating transmission types of point-to-multipoint services, detecting, based on the monitoring, a point-to-multipoint service of interest, further detecting, based on the monitoring, an indication of a transmission type of the point-to-multipoint service of interest, and in response to the detection of the indication of the transmission type of the point-to-multipoint service of interest, sending a request for a configuration enabling reception of the indicated transmission type of the point-to-multipoint service of interest on a point-to-multipoint traffic channel.

In accordance with a further aspect there can be provided a method for receiving point-to-multipoint services, comprising monitoring, by a receiver device, a control channel configured for carrying information indicating transmission types of point-to-multipoint services, detecting, based on the monitoring, a point-to-multipoint service of interest, monitoring to further detect an indication of a transmission type of the point-to-multipoint service of interest, and when the indication of a transmission type of the point-to-multipoint service of interest is detected, sending a request for a configuration enabling reception of the indicated transmission type of the point-to-multipoint service on a point-to-multipoint traffic channel, and when no indication of a transmission type of a point-to-multipoint service of interest is detected, refraining from sending the request for the configuration for reception of the transmission type of the point-to-multipoint service.

In the further aspect, when refraining from requesting for configuration for a transmission type of a point-to-multipoint service, the monitoring for point-to-multipoint transmissions on the point-to-multipoint traffic channel may be based on synchronization signal blocks.

In accordance with yet another aspect there can be provided method for controlling point-to-multipoint services, comprising sending, on a control channel configured for carrying information indicating transmission types of point-to-multipoint services, an indication of a transmission type of a point-to-multipoint service for use by receiver devices, if the point-to-multipoint service is of interest, in determining whether to request for a configuration associated with the transmission type in order to receive the point-to-multipoint service of interest on a traffic channel, receiving in response a request from at least one receiver device for a configuration enabling reception by the receiver device of the indicated transmission type on a point-to-multipoint traffic channel, and sending the configuration to the at least one receiver device.

The point-to-multipoint services may comprise multicast broadcast services, the indication of the transmission type may comprise an indication of a tracking reference signal for a multicast broadcast service, the control channel may comprise a multicast control channel, and/or the traffic channel may comprise a multicast traffic channel. The configuration information may be provided in a system information block. A tracking reference signal configuration may be provided in a system information block for a broadcast service. The configuration may be provided on a broadcast channel.

The methods may further comprise processing information indicating which configuration of a multiple of possible configurations is to be used by the receiver device.

The receiver device monitoring the control channel may be in a radio resource control idle or inactive state.

Means for implementing the herein disclosed operations and functions can also be provided. The means can comprise appropriately configured hardware and/or software. Examples for the means are described in the detailed description.

A computer software product embodying at least a part of the herein described functions may also be provided. In accordance with an aspect a computer program comprises instructions for performing at least one of the methods described herein.

### BRIEF DESCRIPTION OF DRAWINGS

Some aspects will now be described in further detail, by way of example only, with reference to the following examples and accompanying drawings, in which:

FIG. 1 illustrates an example of a system where the invention can be practiced;

FIG. 2 shows an example of a control apparatus; and

FIGS. 3 to 6 show flowcharts according to certain examples.

### DETAILED DESCRIPTION OF EXAMPLES

The following description gives an exemplifying description of some possibilities to practise the invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

Wireless communication systems provide wireless communications to devices connected therein. Typically, an access node such as a base station is provided for enabling the communications. In the following, different scenarios will be described using, as an example of an access architecture, a 3GPP 5G radio access architecture. However, the examples are not necessarily limited to such an architecture. Some examples of options for suitable systems are the universal mobile telecommunications system (UMTS) radio access network (UTRAN or E-UTRAN), long term evolution (LTE), LTE-A (LTE advanced), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs), cellular internet of things (IoT) RAN and Internet Protocol multimedia subsystems (IMS) or any combination and further development thereof.

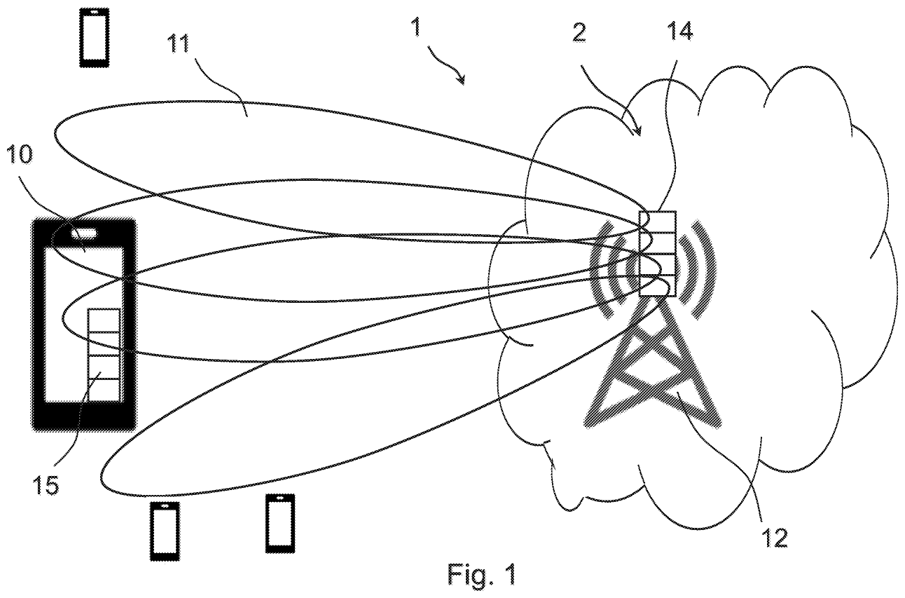

FIG. 1 shows a wireless system 1 comprising a radio access system or radio access network (RAN) 2. A radio access system can comprise one or a plurality of access nodes 12, such as access points or base stations. An access node may provide one or more cells. Each cell can provide radio beams 11. The beams can be provided by means of analogue or digital or hybrid beamforming. The example is shown schematically to comprise up to four beams per polarization in spatial domain (SD). An access node can comprise any node that can transmit/receive radio signals (e.g., a TRP, a 3GPP 5G base station such as gNB, eNB, a user device such as a UE and so forth). It is noted that a great number of radio access systems can be provided in a communication system.

A communications device 10 is located in the service area of the radio access system 2, and the device 10 can thus listen to and receive from and transmit to the access node 12. The communications from the device 10 to the access node 12 is commonly referred to as uplink (UL). The communications from the access node 12 to the device 10 is commonly referred to as downlink (DL).

It is noted that the wider communication system is only shown as cloud 1 and can comprise a number of elements which are not shown for clarity. For example, a 5G based system may be comprised by a terminal or user equipment (UE), a 5G radio access network (5GRAN) or next generation radio access network (NG-RAN), a 5G core network (5GC), one or more application function (AF) and one or more data networks (DN). The 5G-RAN may comprise one or more gNodeB (GNB) or one or more gNodeB (GNB) distributed unit functions connected to one or more gNodeB (GNB) centralized unit functions. The 5GC may also comprise entities such as Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); Session Management Function (SMF) and so on.

The device 10 may be any suitable device adapted for wireless communications. The device 10 may comprise a user equipment (UE). A wireless communication device may be provided by any device capable of sending and receiving radio signals. Non-limiting examples comprise a mobile station (MS) (e.g., a mobile device such as a mobile phone or what is known as a ‘smart phone’), a computer provided with a wireless interface card or other wireless interface facility (e.g., USB dongle), personal data assistant (PDA) or a tablet provided with wireless communication capabilities, machine-type communications (MTC) devices, Internet of Things (IoT) type communications devices, a Cellular Internet of things (CIoT) device or any combinations of these or the like. The device may be provided as part of another device. The device may receive signals over an air or radio interface via appropriate apparatus for receiving and may transmit signals via appropriate apparatus for transmitting radio signals. The communications can occur via multiple paths. To enable MIMO type communications devices 10 and 12 may be provided with multiantenna elements. These are schematically denoted by antenna arrays 14 and 15.

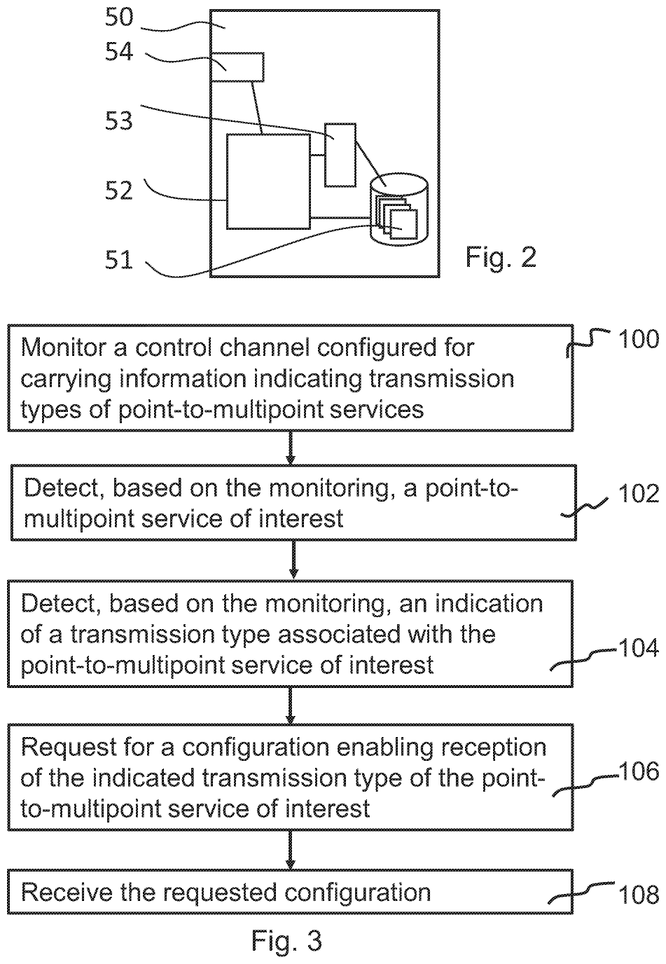

A communications device such as the access node 12 or the user device 10 is provided with data processing apparatus comprising at least one processor and at least one memory. FIG. 2 shows an example of a data processing apparatus 50 comprising processor(s) 52, 53 and memory or memories 51. FIG. 2 further shows connections between the elements of the apparatus and an interface for connecting the data processing apparatus to other components of the device.

The at least one memory may comprise at least one ROM and/or at least one RAM. The communications device may comprise other possible components for use in software and hardware aided execution of tasks it is designed to perform, including control of access to and communications with access systems and other communications devices, and implementing the herein described features of positioning of the device. The at least one processor can be coupled to the at least one memory. The at least one processor may be configured to execute an appropriate software code to implement one or more of the following aspects. The software code may be stored in the at least one memory, for example in the at least one ROM.

The following describes certain aspects, configurations and signaling for data transmission related operations using 5G terminology. An independent radio resource control (RRC) state for inactive UEs, referred to as RRC_INACTIVE complements states RRC_CONNECTED and RRC_IDLE to provide a state for efficient support of services between the RRC_CONNECTED and RRC_IDLE states. The RRC_INACTIVE state enables quick resume of an earlier suspended connection and start of transmission of small or sporadic data with low initial access delay and associated signalling overhead compared to the RRC_IDLE state. A UE in RRC_INACTIVE is able to achieve power savings, benefiting from, e.g., s larger period of PDCCH monitoring and relaxed measurements compared to RRC_CONNECTED.

Point-to-multipoint communications refers to one-to-many type of communications where a station, for example a base station or another radio access node (e.g., a 5G gNB) of a mobile communication system can transmit a simultaneous multicast or broadcast to more than one receiving device in its service area. Such services can comprise multicast and/or broadcast services, often referred to as multicast broadcast services where, unlike in unicast services where unicast addresses are used as destination addresses, data can be transmitted simultaneously from a single source to multiple destinations/devices. Broadcast refers to the ability to deliver content to all users. This may be done by setting a broadcast address as a destination address. Multicast refers to distribution of content for services among a specific group of devices or users that are subscribed to those services. This may be done by setting a multicast address as a destination address. Multicast Broadcast Service (MBS) defined by the 3GPP is a more specific example of point-to-multipoint communication schemes.

The following describes certain aspects, configurations and signaling for point-to-multipoint operations using 5G terminology. The multicast and/or broadcast content may be transmitted over a geographical area services by the access node 12. An MBS zone is a collection of one or more network access nodes (e.g., base stations) that are capable of transmitting the same content. An MBS zone may be also referred to as MBS service area within which data of multicast or broadcast session is sent. 3GPP 5G standardisation is currently working on delivery mechanisms of multicast/broadcast traffic to a multitude of receiving devices (UEs). An issue to be resolved is caused by the possibility of using different mechanisms to transmit data of different multicast broadcast services.

To illustrate the possible underlying issues beam sweeping is considered next as an example. Beam Sweeping is a technique for transmitting beams from a station in predefined directions in a burst. In the following certain particular aspects of supporting beam sweeping for broadcasting applications are described in relation to delivery of a Tracking Reference Signal (TRS) for broadcast, e.g., for idle or inactive user equipment (UE), with reference to Multicast Broadcast Service (MBS) in accordance with the 3GPP. Such UEs can be in radio resource control (RRC) IDLE/INACTIVE state. Beam sweeping can be supported for the MBS based on Quasi-Colocation (QCL) associated with a Synchronization Signal Block (SSB). Another option is to use QCL associated with periodic TRS if configured in a System Information Block (SIB) for broadcast reception. Quasi-Colocation (QCL) is commonly understood to refer to an arrangement where two antenna ports are said to be quasi co-located if properties of the channel over which a symbol on one antenna port is conveyed can be inferred from the channel over which a symbol on the other antenna port is conveyed. Both alternatives may need to be supported by a receiver device as some MBS services can be TRS-based and some others SSB-based. A device receiving an MBS service may need to determine whether the MBS service is TRS-based or SSB-based. This information can then be used in decoding physical channels carrying the MBS service, e.g., group-common Physical Downlink Control Channel (PDCCH) and group-common Physical Downlink Shared Channel (PDSCH). For an SSB-based MBS service the physical channels can be decoded using the QCL information of SSB. For an TRS-based MBS service the physical channels can be decoded using the QCL information of the TRS. To support TRS-based MBS Services, TRS configuration(s) can be carried in a MBS-TRS-SIB. The MBS-TRS-SIB is intended for all UEs receiving MBS services. Only idle/inactive UEs which are associated with the TRS-based MBS may however need to receive the TRS configuration over a broadcast channel. For a connected UE, the base station may provide the MBS-TRS-SIB over dedicated control signalling assuming the connected UE provided the base station with information regarding its interest to receive TRS-based multicast or broadcast service.

It is noted that not all MBS services are necessarily associated with one of the above two exemplifying possibilities, but other broadcast services may also be provided.

Different point-to-multipoint services can also have different characteristics, e.g., in terms of robustness requirements and traffic channel payload size. This can have a meaning in determining whether a specific configuration is needed. For instance, for some of the broadcast services it is beneficial to apply SSB-based scheme with a lower modulation to guarantee a more robust reception. For other broadcast services enabling large traffic channel payload size higher modulation with, e.g., the TRS scheme can be more preferred. For example, this can provide higher spectral efficiency and improved reception of higher order modulation. Thus, different broadcast services can be used with either SSB or TRS. As a result, some of the broadcast services can use the SSB-based scheme, and other broadcast services can use the TRS-based scheme. The RRC_IDLE/INACTIVE UEs that receive the TRS-based broadcast services may require TRS configuration information. It is noted that not all services require all MBS RRC_IDLE/INACTIVE UEs to receive the TRS configuration.

Examples of mechanisms providing selectivity in providing configuration to the receiver devices are described below. Certain detailed examples are given for selectively providing MBS-TRS configuration to idle/inactive UEs.

An example of general principles of operation of a device configured to receive point-to-multipoint transmissions is shown in FIG. 3. In the shown method for receiving point-to-multipoint services, the receiver device monitors at 100 a control channel configured for carrying information indicating transmission types of point-to-multipoint services. At 102 a point-to-multipoint service of interest is detected based on said monitoring. An indication of a transmission type associated with the point-to-multipoint service of interest is detected 104. In response thereto a request is sent at 106 for a configuration enabling reception of the indicated transmission type of the point-to-multipoint service of interest on a point-to-multipoint traffic channel.

The requested configuration can then be received at 108 and used for reception of the service of interest.

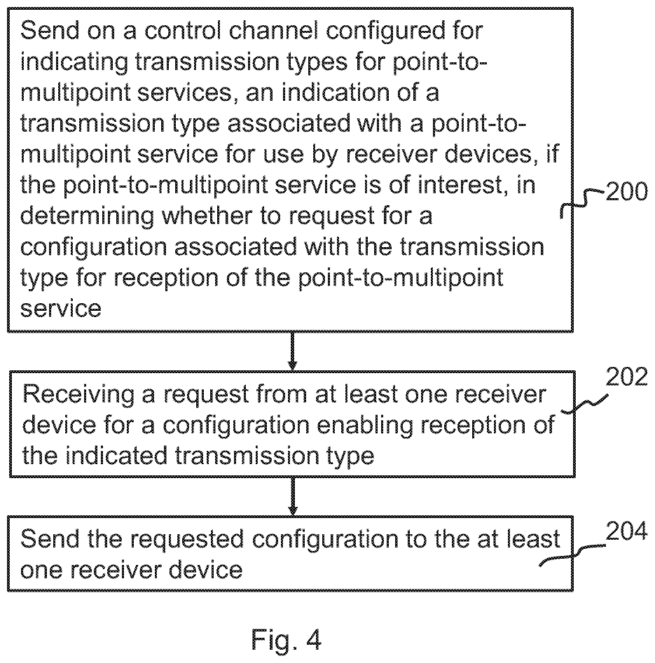

FIG. 4 shows an example for operation at an access node transmitting point-to-multipoint services to receiver devices for controlling the point-to-multipoint services. In the method the station sends at 200, on a control channel configured for carrying information indicating transmission types of point-to-multipoint services, an indication of a transmission type of a point-to-multipoint service for use by receiver devices, if the point-to-multipoint service is of interest, in determining whether to request for a configuration associated with the transmission type in order to receive the point-to-multipoint service of interest on a traffic channel. At 202 the access node receives in response a request from at least one receiver device for a configuration enabling reception by the receiver device of the indicated transmission type on a point-to-multipoint traffic channel. The requested configuration is sent at 204 to the at least one receiver device.

For idle/inactive receiver devices, the configuration may be signalled on a broadcast channel, for example in SIBs (e.g., MBS-TRS-SIB). For connected devices, the sending can be provided differently, for example as explained above.

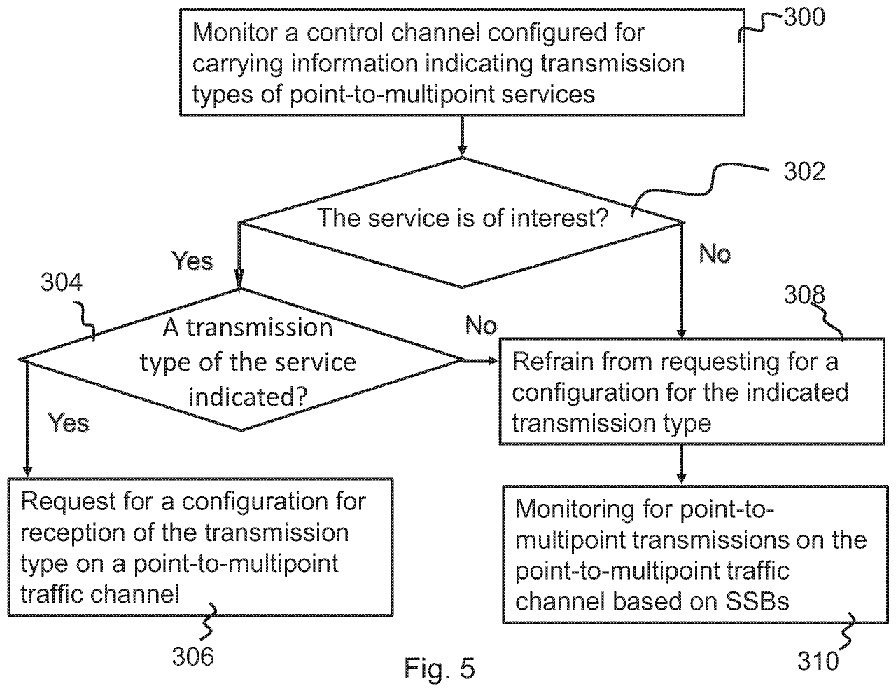

FIG. 5 shows another example for operation at a receiver device for receiving point-to-multipoint services. In this example the device monitors at 300 a control channel configured for carrying information indicating transmission types of point-to-multipoint services. The device determines at 302 whether the point-to-multipoint service is of interest I. If yes, the device can detect, based on the monitoring, at 304 an indication of a transmission type of the point-to-multipoint service of interest. If the indication is detected, a request can be sent at 306 for a configuration enabling reception of the indicated transmission type of the point-to-multipoint service on a point-to-multipoint traffic channel. If no at 302 or 304, i.e., when no transmission type indication of a point-to-multipoint service of interest is detected, the device can refrain at 308 from sending the request for the configuration for reception of the transmission type of the point-to-multipoint service. Monitoring for point-to-multipoint transmissions can in that case be provided on the point-to-multipoint traffic channel based on, e.g., SSBs.

The types can be indicated by explicit or implicit indications.

The configuration can be signaled in a system information block. The configuration may comprise signaling a tracking reference signal configuration for a broadcast service.

When a receiver device decides refrains from requesting for the configuration for a transmission type of a point-to-multipoint service, it may monitor for point-to-multipoint transmissions on the point-to-multipoint traffic channel based on synchronization signal blocks.

An indication of a transmission type may be associated with a multicast broadcast service. The indication of the transmission type may indicate whether transmissions of the multicast broadcast service are based on a tracking reference signal (TRS) or not.

A receiver device may detect the indication of transmission types associated with different multicast broadcast services. For one or more multicast broadcast services, such indications may not be available.

The control channel may be a multicast control channel (MCCH).

A determination can also be made whether the receiving device already has stored a valid configuration of the indicated transmission type of the point-to-multipoint service. A request for the configuration is then only made if the configuration is not found from the memory of the device, otherwise the existing configuration can be used,

Information may be provided for indicating which configuration of a multiple of possible configurations is to be used by the receiver device.

Turning now to the detailed example relating to the tracking reference signal (TRS) configurations for broadcast services. Whether MBS UEs need to be provided with a TRS configuration or not, depends on whether the MBS service in question is TRS-based or not. An indication that MBS service(s) is (/are) associated with a TRS can be carried via a multicast control channel (MCCH). Delivery of a requested TRS configuration can then be carried via the SIB which can be carried on a broadcast channel, for example broadcast control channel (BCCH). Selective provision of TRS configurations to MBS RRC_IDLE/INACTIVE UEs can assist in optimising use of the spectrum resources.

In accordance with an example a procedure to provide TRS configuration to idle/inactive UEs comprises a possibility for the UE to dynamically decide if it has an interest in receiving a multicast or broadcast service and if the transmission type associated in the multicast or broadcast service is TRS-based transmission, and consequently if it needs a configuration for the service.

Determining the interest may depend, e.g., on the relevant application. For example, some active applications, or services requested by the user via applications, may require certain MBS services. The UE may keep a record of MBS services of interest it wants to receive. If the UE detects on the MCCH an MBS service which is not in such record, it may just neglect the MBS service. If the UE detects an MBS service which it wants to receive based on the in record, the UE may then proceed to checking whether the MBS service is associated with a TRS configuration. And if so, a request for the TRS configuration is sent in order to be able to receive the TRS-based transmissions of the MBS. The records may comprise a service identifier. When the access node provides a new multicast and broadcast service, updated information can be broadcast about available/ongoing services with a service identifier. The receiving devices determines that the service is of interest if the service identifier in its record matches the service identifier broadcast by the network.

An UE in RRC idle/inactive state that is interested to receive an MBS service can first receive, from a gNB, a Multicast Control Channel (MCCH) message comprising an indication of multicast broadcast service transmission type associated with a certain MBS service. Multiple indications and/or services may be provided via the MCCH. If the UE detects the indication for a MBS service it is interested in, the UE can request for an appropriate configuration for the transmission type from the gNB.

A TRS configuration carried via a SIB can have a relatively large packet size. A periodic transmission of a TRS configuration can be carried via the SIB for those MBS services that are associated with the TRS-based scheme. For example, an access node may decide to transmit a TRS configuration via the SIB periodically instead upon a request at least for some time if it has received many requests for the TRS configuration recently. Such situation may happen when new UEs interested in a TRS-based MBS service are continuously arriving to a cell of the access node.

Use of the TRS-based service for a scheme can be indicated to the idle/inactive UEs via the MCCH. Only those idle/inactive UEs who want to receive the TRS-based MBS services need to react to the indication and acquire the TRS configuration from the SIB.

After receiving the TRS configuration, the UE is able to receive the TRS-based MBS data on a Multicast Traffic Channel (MTCH). If the UE does not detect an indication for a MBS service it is interested in, the UE can refrain from requesting a TRS configuration from the gNB. In accordance with a possibility the UE can proceed to monitor SSB based MBS data on the Multicast Traffic Channel (MTCH).

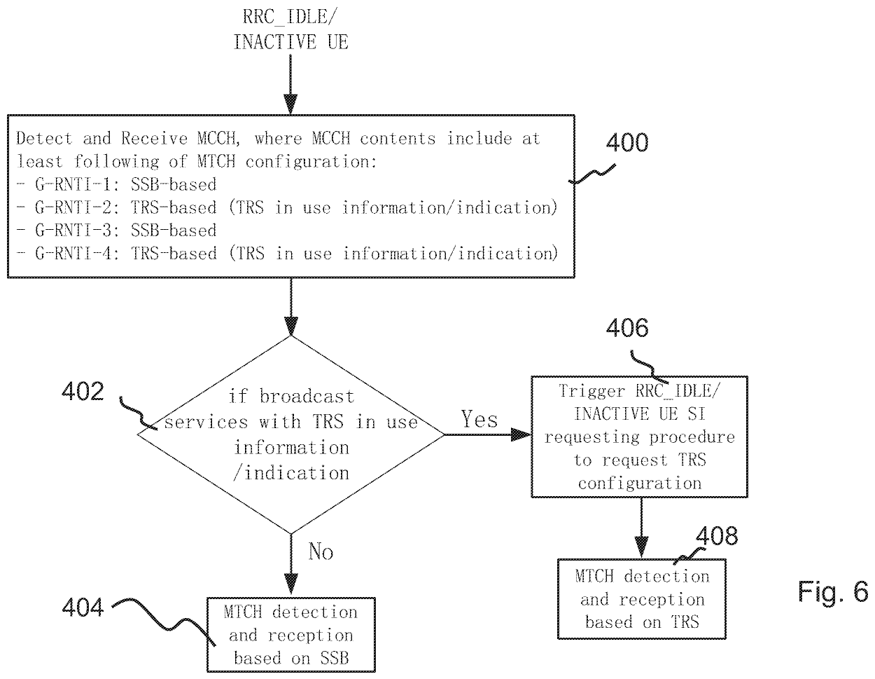

The TRS for MBS can be transmitted in a periodic manner. The TRS-based transmission can be associated with only some of the MBS services. This means that not all MBS services are necessarily based on the TRS. For instance, as shown in block 400 of FIG. 6, the MBS services G-RNTI-1 (service 1) and G-RNTI-3 (service 3) are SSB-based and MBS-services G-RNTI-2 (service 2) and G-RNTI-4 (service 4) are TRS-based. The type can be determined by the UE at 402. UEs receiving MBS service 1 and/or 3 do not need to request TRS configuration from the SIB and can receive services based on the SSB at 404. Only the UEs receiving or interested to receive TRS-based MBS services 2 and/or 4 at 408 are required to trigger at 406 the TRS configuration request from the SIB.

If multiple TRS configurations are used, in addition to the service indication on MCCH a further indication can be provided to tell the UE which one to use. This can be provided, e.g., by means of a pointer or index.

Typically the MCCH control channel is used for carrying the configuration of MTCH. The TRS scheme is rather intended for the traffic channel/MTCH transmission with large payload size. The TRS configuration may be rather large and carrying the TRS configuration in the payload of the MCCH may not be practical or feasible. Instead, the TRS configuration can be carried over a SIB, for example MBS-TRS-SIB. The SIB can be provided on-demand due to the size and because the TRS configuration may change rarely. Thus the UE can request the network to transmit the TRS configuration information only when needed, i.e., when there is a UE interested to receive corresponding TRS-based broadcast services and the transmission type has been indicated. For example, RRC_IDLE/INACTIVE UEs to request for a MBS-TRS-SIB containing the TRS configuration information. The SIB information requesting procedure can be provided according to an appropriate requesting mechanism, e.g., based on what is standardized in 3GPP TS 38.300, or with minimum changes to the existing approach.

Sending of a TRS configuration may be conducted via a legacy System Information (SI) requesting procedure via logical channel, for example DCCH, and further via a physical layer shared channel such as PDSCH. In the physical layer, the MCCH and MTCH comprise a control channel (GroupCommon-PDCCH) and traffic channel (GroupCommon-PDSCH), respectively.

When a UE is informed about use of TRS-based scheme for an MBS broadcast session by means of signalling an information/indication associated with a TRS in use with a certain broadcast service, the TRS indication can be signalled using the MCCH together with other configuration information for the MBS broadcast session. For example, when a RRC_IDLE/INACTIVE UE is interested to receive MBS broadcast services, it can first receive MCCH comprising the service configuration including MTCH configuration and, if the TRS-based scheme is in used, TRS indication and other relevant information. The RRC_IDLE/INACTIVE UE can determine whether it shall request the network to transmit the MBS-TRS-SIB which carries the TRS configuration for MBS, if the MBS-TRS-SIB is not broadcast periodically.

In the above examples sending of relatively large TRS configurations periodically to all receiver devices can be avoided. Instead, only those idle/inactive receiver devices send a request for the configuration that actually have a reason to receive the configuration. There may even be occasions where there are no receiver devices in idle or inactive state in an area that are interested in a broadcast MBS service using a TRS-based scheme, and the network may not be aware of this. In such scenario, broadcasting a SIB with a TRS configuration would be wasteful. The payload size of TRS configurations can be relatively large and transmission of large TRS configurations to all MBS idle/inactive receiver devices or non-interested receiver devices may unnecessarily congest the network. The above exemplified principles can assist in optimizing resource use already for these reasons. In addition, more robust MCCH payload transmission may be achieved. A MCCH that carries control information for a MTCH may not always be feasible for reliably carrying a large TRS configuration.

It is noted that while the above describes example embodiments, there are several variations and modifications which may be made to the disclosed solution without departing from the scope of the present invention. Different features from different embodiments may be combined.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. The hardware and/or the software can provide the necessary means for implementing the various examples.

It is noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. Alternatively, or additionally some embodiments may be implemented using circuitry. The circuitry may be configured to perform one or more of the functions and/or method procedures previously described. That circuitry may be provided in the network entity and/or in the communications device and/or a server and/or a device.

As used in this application, the term “circuitry” may refer to one or more or all of the following:
(a) hardware-only circuit implementations (such as implementations in only analogue and/or digital circuitry);
(b) combinations of hardware circuits and software, such as: (i) a combination of analogue and/or digital hardware circuit(s) with software/firmware and (ii) any portions of hardware processor(s) with software (including digital signal processor(s)), software, and memory(ies) that work together to cause the communications device and/or device and/or server and/or network entity to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

It is noted that whilst embodiments have been described in relation to certain architectures, similar principles can be applied to other systems. Therefore, although certain embodiments were described above by way of example with reference to certain exemplifying architectures for wireless networks, technologies standards, and protocols, the herein described features may be applied to any other suitable forms of systems, architectures and devices than those illustrated and described in detail in the above examples. It is also noted that different combinations of different embodiments are possible. It is also noted herein that while the above describes exemplifying embodiments, there are several variations and modifications which may be made to the disclosed solution without departing from the spirit and scope of the present invention.

1-25. (canceled)

26. An apparatus for a receiver device, comprising at least one processor and at least one memory including a computer program code, the at least one memory and computer program code configured to, with the at least one processor, cause the apparatus at least to:
monitor a control channel configured for carrying information indicating transmission types of point-to-multipoint services,
detect, based on said monitoring, a point-to-multipoint service of interest,
further detect, based on said monitoring, an indication of a transmission type associated with the point-to-multipoint service of interest, and in response send a request for a configuration enabling reception of the indicated transmission type of the point-to-multipoint service of interest on a point-to-multipoint traffic channel, and
in the absence of said further detecting, refrain from sending the request for the configuration for reception of the transmission type of the point-to-multipoint service.

27. The apparatus of claim 26, wherein the point-to-multipoint service comprises a multicast and/or broadcast service, and the indication of the transmission type comprises an indication of a tracking reference signal for the multicast and/or broadcast service.

28. The apparatus of claim 26, wherein the control channel comprises a multicast control channel and the point-to-multipoint traffic channel comprises a multicast traffic channel.

29. The apparatus of claim 26, configured to receive the requested configuration in a system information block.

30. The apparatus of claim 26, wherein the configuration is a tracking reference signal configuration for a multicast broadcast service.

31. The apparatus of claim 26, wherein the at least one processor and at the least one memory including a computer program code, are further configured to signal information indicating which configuration of a multiple of possible configurations is to be used by the receiving devices.

32. The apparatus of claim 26, wherein the at least one receiver device monitoring the control channel is in a radio resource control idle or inactive state.

33. The apparatus of claim 26, wherein the at least one processor and at the least one memory including a computer program code, are further configured to signal the configuration on a broadcast channel.

34. A method for receiving point-to-multipoint services, comprising:
monitoring, by a receiver device, a control channel configured for carrying information indicating transmission types of point-to-multipoint services,
detecting, based on the monitoring, a point-to-multipoint service of interest,
further detecting, based on the monitoring, an indication of a transmission type of the point-to-multipoint service of interest, and
in response to the detection of the indication of the transmission type of the point-to-multipoint service of interest, sending a request for a configuration enabling reception of the indicated transmission type of the point-to-multipoint service of interest on a point-to-multipoint traffic channel.

35. The method of claim 34, wherein the point-to-multipoint services comprise multicast broadcast services, the indication of the transmission type comprises an indication of a tracking reference signal for a multicast broadcast service, the control channel comprises a multicast control channel, and the traffic channel comprises a multicast traffic channel.

36. The method of claim 34, wherein the configuration information is provided in a system information block.

37. The method of claim 34, comprising processing information indicating which configuration of a multiple of possible configurations is to be used by the receiver device.

38. The method of claim 34, wherein the receiver device monitoring the control channel is in a radio resource control idle or inactive state.

39. The method of claim 35, wherein the configuration is provided on a broadcast channel.

40. An apparatus for controlling point-to-multipoint services, comprising at least one processor and at least one memory including a computer program code, the at least one memory and computer program code configured to, with the at least one processor, cause the apparatus at least to:
send, on a control channel configured for carrying information indicating transmission types of point-to-multipoint services, an indication of a transmission type of a point-to-multipoint service for use by receiver devices in determining, if the point-to-multipoint service is of interest, whether to request for a configuration associated with the transmission type in order to receive the point-to-multipoint service of interest on a traffic channel,
receive in response a request from at least one receiver device for a configuration enabling reception, by the receiver device, of the indicated transmission type on a point-to-multipoint traffic channel, and
send the configuration to the at least one receiver device.

41. The apparatus of claim 40, wherein the point-to-multipoint service comprises a multicast and/or broadcast service, and the indication of the transmission type comprises an indication of a tracking reference signal for the multicast and/or broadcast service.

42. The apparatus of claim 40, wherein the control channel comprises a multicast control channel and the point-to-multipoint traffic channel comprises a multicast traffic channel.

43. The apparatus of claim 40, configured to signal the requested configuration to the at least one receiver in a system information block.

44. The apparatus of claim 40, configured to signal information indicating which configuration of a multiple possible configurations is to be used by the receiving devices.

45. The apparatus of claim 40, configured to signal the configuration on a broadcast channel.
